(19) United States
(12) Patent Application Publication
(10) Pub. No.: US 2024/0263706 A1
(43) Pub. Date: Aug. 8, 2024

(54) SEALING CARTRIDGE FOR A HYDROBLASTING TOOL AND HYDROBLASTING TOOL

(71) Applicant: COMET DO BRASIL INVESTIMENTOS LTDA., Indaiatuba/SP (BR)

(72) Inventor: Virgílio ALVES NETO, Indaiatuba/SP (BR)

(73) Assignee: COMET DO BRASIL INVESTIMENTOS LTDA., Indaiatuba/SP (BR)

(21) Appl. No.: 18/434,076

(22) Filed: Feb. 6, 2024

(30) Foreign Application Priority Data
Feb. 6, 2023 (BR) 10 2023 002196-4

(51) Int. Cl. F16J 15/34; B05B 3/00

(52) U.S. Cl. CPC F16J 15/348; B05B 3/003

(57) ABSTRACT

The present invention relates to a sealing cartridge for a hydroblasting tool and a hydroblasting tool. The sealing cartridge (13) for a hydroblasting tool (25), comprising a sealing body (30) comprising a first through hole (37), a first sealing body surface (30a) and a second sealing body surface (30b); a support (29) comprising a second through hole (38), a first support surface (29a) and a second support surface (29b); and a guide (32) comprising a first guide surface (32a) delimiting an opening (39) and a second guide surface (32b) disposed around the opening (39); wherein the first through hole (37), the second through hole (38) and the opening (39) are configured to be axially aligned; the first support surface (29a) is configured to connect with the first sealing body surface (30a); the second support surface (29b) is configured to connect with the second guide surface (32b); and the first guide surface (32a) is configured to connect with the second sealing body surface (30b).

### FIELD OF INVENTION

The present invention relates to a sealing cartridge for a hydroblasting tool and a hydroblasting tool.

### BACKGROUND OF THE INVENTION

High pressure hydroblasting tools are widely used in the naval, petrochemical, automobile and civil construction industries.

A type of hydroblasting tool known in the prior art is the hydroblasting rotary tool, which is intended for the application of high pressure water jets and is mainly used in cleaning, removing and treating surfaces, unblocking pipes and demolishing structures.

The hydroblasting rotary tools may comprise a rotation control system to increase, decrease or stabilize the rotation speed of the tool. Rotation control systems may comprise, for example, centrifugal or magnetic brakes.

Magnetic brake generally operates through a stray current and centrifugal brake generally operates through centrifugal weights immersed in oil.

However, the tools known in the prior art are not configured to implement versatile rotation control systems, which allow the use of different types of brakes on the same tool.

Additionally, it is worth noting that hydroblasting rotary tools operate at high pressure, typically in the range of 1500 to 3000 bar. Therefore, it is essential that these tools have secure sealing means that prevent fluid leakage.

Any fluid leakages in tools operating at high pressure can cause serious and even fatal accidents for their operators. Additionally, equipment repairs may be required, leading to more costs and lost productivity due to downtime.

A means of sealing widely known in the art are sealing cartridges.

However, sealing cartridges known in the prior art have a large number of parts and complex configuration, which increases production costs and makes tool maintenance difficult in the field.

Furthermore, no hydroblasting tools are known in the art that comprise a sealing cartridge that is adaptable to different types of brakes, that is, sealing cartridges are usually adapted for a single type of brake.

Furthermore, prior art tools present a high chance of jamming (locking, cramming) during operation, which is particularly common in tools that have a centrifugal brake and is due, without being attached to any specific theory, to the high number of parts required for building the tool.

Document U.S. Pat. No. 8,573,599B2 mentions a cartridge assembly for use in a high pressure hydroblasting rotary tool.

The hydroblasting rotary tool in document U.S. Pat. No. 8,573,599B2 features a centrifugal brake that can be seen in FIG. 3. However, the document does not describe that the tool can be adaptable to different types of brakes and, furthermore, it does not describe that the cartridge assembly is adaptable to different types of brakes.

Furthermore, the configuration of the cartridge in document U.S. Pat. No. 8,573,599B2 is complex, comprising a large number of components, which makes its manufacturing and eventual maintenance in the field difficult.

Document U.S. Pat. No. 9,321,067B2 mentions a sealing cartridge and an ultra-high pressure rotary nozzle assembly, which comprises a braking device that is a magnetic brake assembly that operates by means of stray current (also known as a “magnetic brake”).

However, document U.S. Pat. No. 9,321,067B2 does not provide details that the disclosed rotating nozzle assembly may comprise other types of brakes in addition to the magnetic brake device. Furthermore, no details are provided about the sealing cartridge being adaptable to different types of brakes.

Document EP1068021B1 mentions a high pressure spray nozzle comprising a rotation speed control mechanism using a centrifugal actuator, comprising a tripartite weight. Furthermore, the document mentions a sealing support.

However, document EP1068021B1 does not mention that the high pressure spray nozzle comprises different types of brakes, and further does not mention that the sealing support is adaptable to different types of brakes.

In view of the above, it was noted that no hydroblasting tool known in the prior art allows different types of brakes to be assembled using the same set of parts and, furthermore, no tool comprises a simple configuration sealing cartridge that can be applied to different types of brakes and facilitates tool maintenance in the field.

Consequently, the need to develop an improved hydroblasting tool and sealing cartridge was noted. The present invention addresses this and other goals.

### DESCRIPTION OF THE INVENTION

The goal of the present invention is to provide a hydroblasting rotary tool that allows more than one type of brake, such as centrifugal or magnetic, to be mounted on the same set of parts.

Another goal of the invention is to provide a sealing cartridge adaptable to different types of brakes, wherein the sealing cartridge comprises a simple configuration, with few components, to facilitate field maintenance.

Additionally, another goal of the invention is to provide a hydroblasting tool that is more reliable and less susceptible to jamming.

These and other goals of the invention are achieved by means of a sealing cartridge for a hydroblasting tool comprising a sealing body comprising a first through hole, which hole defines a first dynamic sealing surface when mounted to the hydroblasting tool, a first sealing body surface and a second sealing body surface; a support comprising a second through hole, a first support surface and a second support surface; a joint and a guide comprising a first guide surface delimiting an opening and a second guide surface disposed around the opening; wherein the first through hole, the second through hole and the opening are configured to be axially aligned. The first support surface is configured to connect with the first sealing body surface; the second support surface is configured to connect with the second guide surface; and the first guide surface is configured to connect with the second sealing body surface, wherein the sealing body is fully inserted into the guide.

Other goals of the invention are achieved by a hydroblasting tool comprising a main structure comprising a geometric axis; a rotating structure; the rotating structure being configured to rotate about the geometric axis; and a sealing cartridge; wherein the sealing cartridge is configured to provide a seal between the rotating structure and the main structure. The sealing cartridge comprising: a sealing body comprising a first through hole, which hole defines a first dynamic sealing surface when mounted to the hydroblasting tool, a first sealing body surface and a second sealing body surface; a support comprising a second through hole, a first support surface and a second support surface; and a guide comprising a first guide surface delimiting an opening and a second guide surface disposed around the opening; wherein the first through hole, the second through hole and the opening are configured to be axially aligned and define a fluid passage. The first support surface is configured to connect with the first sealing body surface; the second support surface is configured to connect with the second guide surface; and the first guide surface is configured to connect with the second sealing body surface, wherein the sealing body is fully inserted into the guide.

Also, other goals of the present invention are achieved by a hydroblasting tool comprising a main structure comprising a geometric axis; and a rotating structure; the rotating structure being configured to rotate about the geometric axis; wherein the rotating structure comprises a centrifugal brake for controlling rotation speed, the centrifugal brake comprising a first weight element, a second weight element, a centrifugal shaft and an elastic element, wherein the first weight element comprises a first gap and the second weight element comprises a second gap; wherein the first gap is configured to connect with the second gap and the weight elements are secured to each other by means of an elastic component disposed along the first gap and the second gap. The weight elements surrounding at least a part of the centrifugal shaft; and the elastic element surrounds at least one end of the weight elements and at least one end of the centrifugal shaft.

### BRIEF DESCRIPTION OF THE DRAWINGS

The goals, technical effects and advantages of the present invention will be apparent to those skilled in the art from the detailed description below, which makes reference to the attached figures, which illustrate exemplary, but not limiting, embodiments of the claimed objects.

FIG. 1 shows an exploded view of the sealing cartridge, object of the present invention.

FIG. 1a shows a detailed view of the sealing cartridge support, object of the present invention.

FIG. 1b shows a detailed view of the sealing body of the sealing cartridge, object of the present invention.

FIG. 2 shows a sectional and enlarged view of the sealing cartridge in a configuration mounted on a hydroblasting tool, object of the present invention.

FIG. 3 shows a perspective view of the hydroblasting tool, object of the present invention.

FIG. 4 shows the magnetic brake applied to the hydroblasting tool, object of the present invention.

FIG. 5 shows the centrifugal brake applied to the hydroblasting tool, object of the present invention.

FIG. 5a shows a detailed view of the hydroblasting tool, object of the present invention.

FIG. 6 shows an exploded view of the tool using a magnetic brake.

FIG. 7 shows an exploded view of the tool using centrifugal brake.

FIG. 8 shows the centrifugal axis applied to the hydroblasting tool, object of the present invention.

FIG. 9 shows the first and second weight elements of the hydroblasting tool, object of the present invention.

FIG. 10 shows the elastic element of the hydroblasting tool, object of the present invention.

### DESCRIPTION OF EMBODIMENTS OF THE INVENTION

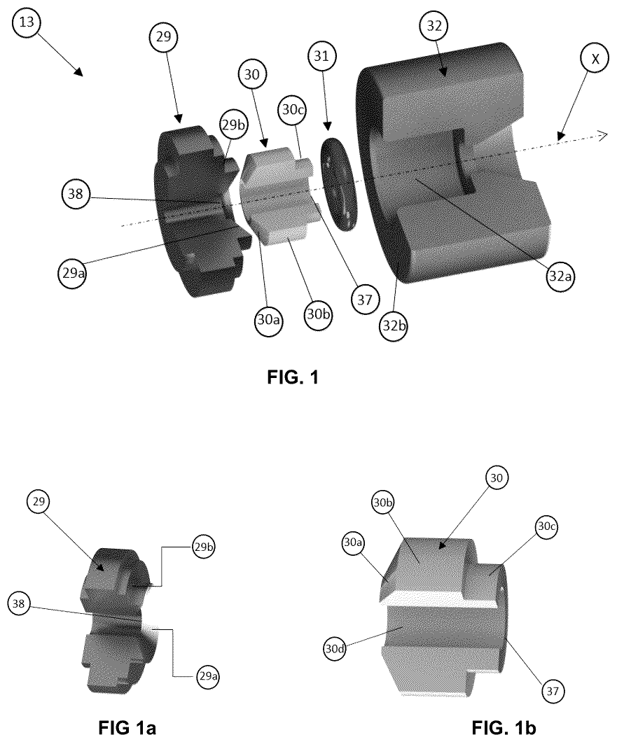

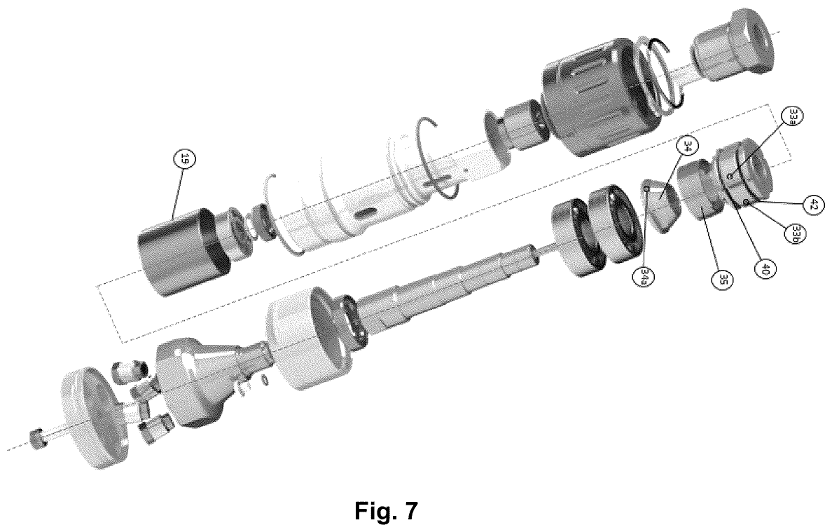

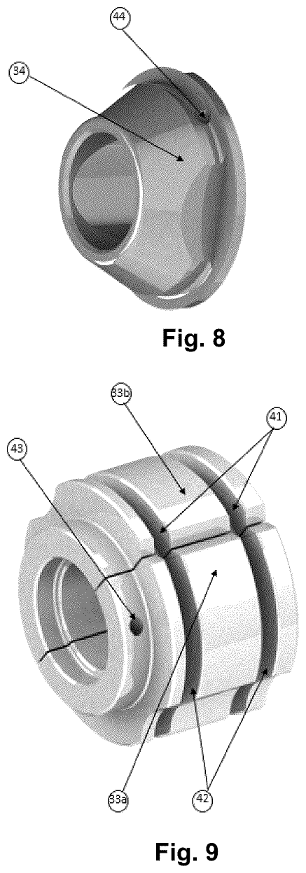

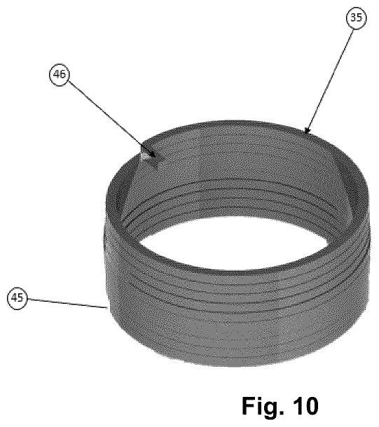

Initially, it should be noted that the sealing cartridge and the hydroblasting tool, objects of the present invention, will be described below according to particular embodiments represented in the attached FIGS. 1 to 10, but not limiting, since their embodiments may be carried out in different ways and variations and according to the application desired by the person skilled in the art.

The use of the term “a” or “an” in this specification does not indicate a limited quantity, but the existence of at least (no less than) one of the elements/components/items listed. Use of the term “or” indicates any or all of the elements/components/items listed. The use of the term “comprise”, “endowed”, “provided” or a similar term indicates that the element/component/item listed in front of said term is part of the invention, but does not exclude other elements/components/items not listed. The use of the term “associate”, “connect” or similar terms may refer to physical, mechanical, pneumatic, fluidic, hydraulic, electrical, electronic or wireless connections, whether directly or indirectly.

The present invention generally relates to a sealing cartridge 13 for a hydroblasting tool 25.

The sealing cartridge 13 comprises a sealing body 30 comprising a first through hole 37, which hole defines the dynamic sealing surface 30d when mounted to the hydroblasting tool, a first sealing body surface 30a and a second sealing body surface 30b.

The sealing cartridge 13 further comprises a support 29 comprising a second through hole 38, a first support surface 29a and a second support surface 29b.

Further, the sealing cartridge 13 comprises a guide 32. The guide 32 comprises a first guide surface 32a delimiting an opening 39 and a second guide surface 32b disposed around the opening 39.

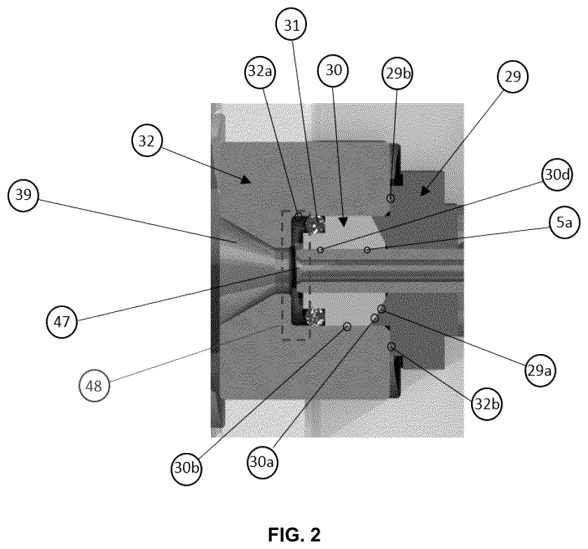

As seen, for example, in FIG. 2, in which the opening 39, a pressurized fluid pocket 48 and a third through hole 47 are configured to be axially aligned and define a fluid passage. The third through hole 47 being in fluid communication with the opening 39.

The first support surface 29a is configured to connect with the first sealing body surface 30a.

Similarly, the second support surface 29b is configured to connect with the second guide surface 32b.

Further, the first guide surface 32a is configured to connect with the second sealing body surface 30b.

The support 29 is made from a metallic material, preferably bronze, the sealing body 30 is made from engineering plastic material, the joint 31 is made from nitrile rubber and the guide 32 is made from stainless steel. It should be noted that the materials described are only examples for carrying out the invention and do not represent an obligation to reproduce the invention. A person skilled in the art could choose other types of materials, as long as they have mechanical characteristics similar to those of the materials described.

In one embodiment, the second guide surface 32b is disposed around the opening 39 and in contact with the second support surface 29b.

Generally, the first sealing body surface 30a has a shape substantially corresponding to the shape of the first support surface 29a to permit engagement of the sealing body 30 and the support 29 in an assembled configuration of the cartridge 13.

In an embodiment illustrated in FIGS. 1 and 2, the first sealing body surface 30a has a frusto-conical shape, corresponding to the shape of the first support surface 29a. The frusto-conical shape facilitates alignment between the parts and the seal.

In another embodiment, at least a portion of the opening 39 has a cylindrical shape.

Continuing, the second sealing body surface 30b has a cross-section of a shape corresponding to the second guide surface 32a.

In one embodiment, the sealing body 30 has a circular cross section.

In one embodiment, the cartridge 13 also comprises a joint 31 which in an assembled configuration of the cartridge 13 is disposed on a shoulder 30c of the sealing body 30. In this way, the joint 31 performs a seal between the first guide surface 32a and the second sealing body surface 30b, preventing fluid leakage from occurring.

In operation, see FIG. 2, the sealing body 30 must never be inserted into the opening 39 so that a pocket of pressurized fluid 48 is created, which exerts a dynamic load on the joint 31 which, in contact with the shoulder 30c, compresses the sealing body 30 on the first support surface 29a, in such a way that increases the friction between the first dynamic sealing surface 30d and the second dynamic sealing surface 5a, preventing fluid leakage and defining a fluid passage.

In one embodiment, the shoulder 30c may have, for example, a circular shape and the joint 31 may have, for example, a toroidal shape, like an O-ring.

However, a person skilled in the art can easily understand that the shoulder 30c and the joint 31 can comprise other shapes, as long as they cooperate with each other. For example, in another embodiment not illustrated, the shoulder 30c has a square shape and the joint 31 also has a square shape, allowing the joint 31 to fit into the respective shoulder 30c for sealing.

The second support surface 29b in an assembled configuration of the sealing cartridge 13 is in contact with the second guide surface 32b.

As seen, for example, in FIG. 1, the first and second support surfaces 29a, 29b comprise shoulders arranged concentrically around a geometric axis X.

In one embodiment, the first and second support surfaces 29a, 29b may comprise circular shoulders.

However, the shoulders can be of other shapes, such as squares.

In an assembled configuration of the sealing cartridge 13, the sealing body 30, the support 29, the sealing guide 32 and the joint 31 are arranged coaxially with respect to the geometric axis X.

The fluid passage defined by the opening 39, the pressurized fluid pocket 48 and the third through hole 47 are arranged parallel to the geometric axis X.

During operation of the tool 25, fluid from a fluid source passes through the fluid passage defined by the opening 39, the pressurized fluid pocket 48 and the third through hole 47. In an assembled configuration of the cartridge 13 and during operation of the tool 25, the cartridge 13 performs the sealing, preventing fluid leakages from occurring and avoiding accidents.

The diameters of the holes 37 and 38 and the opening 39 have substantially the same diameter, differentiated by their manufacturing tolerances. Thus, a person skilled in the art will immediately realize that the diameters must be sized to meet their design requirements, for example, dynamic, static and/or guide sealing.

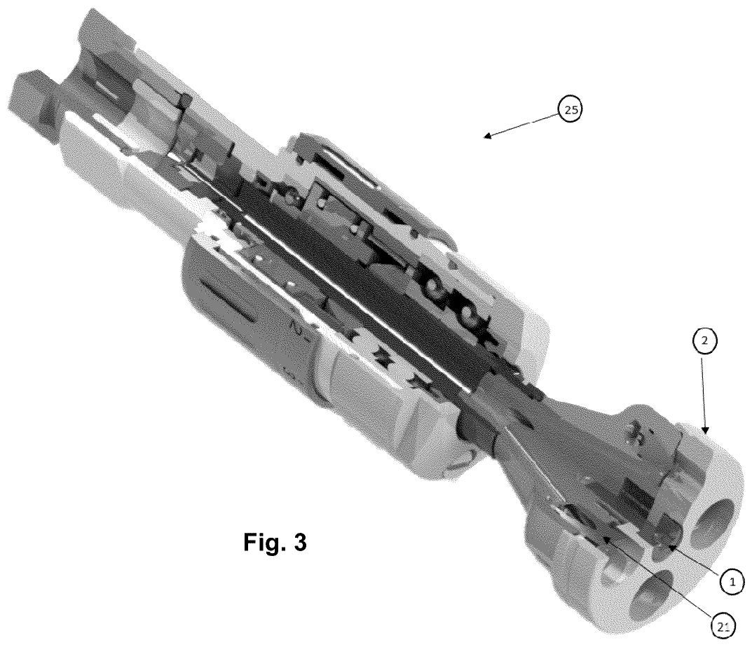

In another embodiment of the invention, a hydroblasting tool 25 is provided, illustrated for example in FIGS. 3 to 7.

The hydroblasting tool 25 comprises a main structure comprising an X axis and a rotating structure.

The rotating structure is configured to rotate around the geometric axis X.

The tool further comprises a sealing cartridge 13 as set forth above in the present invention. The sealing cartridge 13 is configured to provide a seal between the rotating structure and the main structure.

In one embodiment, the hydroblasting tool 25 may be a rotating nozzle.

Preferably, the hydroblasting tool 25 is configured to operate at a pressure of up to 3000 bar, rotation between 1800 and 2400 rpm and flow rates of up to 50 l/min.

The hydroblasting tool 25 comprises a brake for controlling rotation speed, wherein the brake is interchangeable and is selected from a group consisting of magnetic brake 26 and centrifugal brake 27.

The magnetic brake 26 comprises a magnetic rotor 7 comprising a set of permanent magnets and a tubular electrical conductor 19 immersed in oil. The rotor 7 and the conductor 19 are arranged around the mechanical axis 5 and are configured to control the rotation speed thereof. The principle of operation of the magnetic brake is based on Focault current (Eddy current) or stray current.

The rotor 7 has its movement along the geometric axis X limited by means of an elastic ring 8, which is arranged around the mechanical axis 5.

Furthermore, the electrical conductor 19 can be adapted to receive a limiting screw 20, which prevents oil from leaking out of the tool 25 and couples with the handle 11.

In one embodiment, where the magnetic brake 26 is applied, the body 14 has a gap for the passage of the limiting screw 20, allowing coupling between the handle 11 and the electrical conductor 19, so when rotating the handle 11 around the geometric center electrical conductor 19 that changes the immersed portion of the rotating magnetic field of the rotor 7 in the electrical conductor 19, which changes the stray current generated and consequently the rotation of the rotating assembly, allowing a fine adjustment of the rotation of the tool 25.

The centrifugal brake 27 comprises a first weight element 33a, a second weight element 33b, a centrifugal shaft 34 and an elastic element 35.

In one embodiment, the main structure of the hydroblasting tool 25 comprises a body 14 and the rotating structure comprises a mechanical shaft 5.

The body 14 comprises a cavity 36 configured to receive the mechanical shaft 5 and the sealing cartridge 13; wherein the fluid passage defined by the opening 39, pressurized fluid pocket 48 and the third through hole 47 are configured to receive one end of the mechanical shaft 5.

The hydroblasting tool 25 further comprises an adapter 23 configured to fluidically connect a fluid source to the fluid passage.

The adapter 23 is received in the cavity 36 of the body 14 and an adapter joint 12 locks between the cartridge 13 and the cavity 36 of the body 14.

In another embodiment, a hydroblasting tool 25 is provided that comprises a main frame, wherein the main frame comprises an X axis.

The tool 25 also comprises a rotating structure, which is configured to rotate around the geometric axis X.

The rotating structure comprises a centrifugal brake 27 for controlling rotation speed, the centrifugal brake 27 comprising a first weight element 33a, a second weight element 33b, a centrifugal shaft 34 and an elastic element 35 (e.g., a helical spring torsion).

The first weight element 33a comprises a first gap 41 and the second weight element 33b comprises a second gap 42.

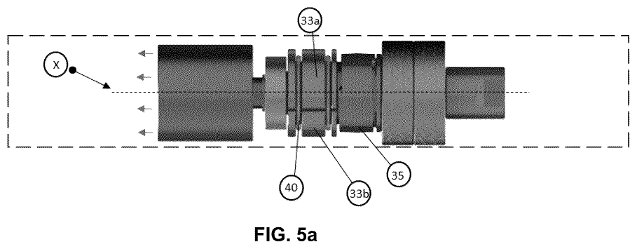

The first gap 41 is configured to connect with the second gap 42 and the weight elements 33a and 33b are secured to each other by means of an elastic component 40, such as, for example, a spring disposed along the first gap 41 and of the second gap 42, which are aligned in an assembled configuration of the centrifugal brake 27. This alignment of the gaps 41, 42 can be observed, for example, in FIG. 9. In FIG. 5, it is observed that, for example, the elastic component 40 may alternatively be an O-ring.

The depth of the gaps 41, 42 is preferably the same and uniform. In one embodiment, the depth of the gaps 41, 42 is one to three times the cross-sectional diameter of the elastic component 40 (width of the elastic component 40). In an embodiment illustrated in FIG. 5, the depth of the gaps 41, 42 is approximately twice the diameter of the cross section of the elastic component 40, such a configuration provides oil deposit which, due to the principle of viscous dissipation, assists the centrifugal brake 27 in rotation control function.

The weight elements 33a, 33b surround at least a part of the centrifugal shaft 34 while the elastic element 35 surrounds at least one end of the weight elements 33a, 33b and at least one end of the surface of the centrifugal shaft 34a.

As seen, for example, in FIG. 5, the weight elements 33a, 33b are accommodated in a recess surrounding the centrifugal shaft 34. Furthermore, it is noted that the centrifugal shaft 34 is arranged around the mechanical shaft 5, surrounding it, in order to limit/control its rotation speed during tool operation 25.

Furthermore, the first weight element 33a comprises a first cavity 43 and the centrifugal shaft 34 comprises a second cavity 44.

In one embodiment, the first and second cavities 43, 44 are configured to receive ends 45, 46 of the elastic element 35. In this way, the elastic element 35 is connected to the centrifugal shaft 34 and the first weight element 33a.

In another embodiment, the centrifugal brake 27 is immersed in oil and comprises a split weight 33a, 33b (i.e., only two weight elements are used). Thus, fewer components are required to construct the centrifugal brake 27 in relation to the prior art.

As illustrated, for example, in FIG. 5, a tubular-shaped casing 28 is configured to accommodate the components of the centrifugal brake 27 in an interior volume. The casing 28 also helps prevent oil leakage to the outside of the tool 25.

In one embodiment, tool 25 comprises additional components such as fixing screw 1, nozzle holder protection 2, front nut 3, retainers 4 and 16, ball bearings 6 and 18, snap rings 10 and 17, O-rings 9, 12 and 15, handle 11, nozzles 21, nozzle holder 22 and washer 24.

Furthermore, protection 2 comprises at least one cavity for receiving the fixing screw 1, in addition to a plurality of holes for fluid exit through the nozzles 21.

Screw 1 is configured to secure the nozzle holder 22 to the nozzle holder protection 2 via a threaded connection. As seen in FIG. 3, the screw 1 is received in at least one central cavity of the protection 2 and in a cavity of the nozzle holder 22.

The nozzle holder 22 comprises a body of generally frusto-conical shape tapering towards a threaded end, which is adapted to connect to a corresponding threaded surface of the mechanical shaft 5.

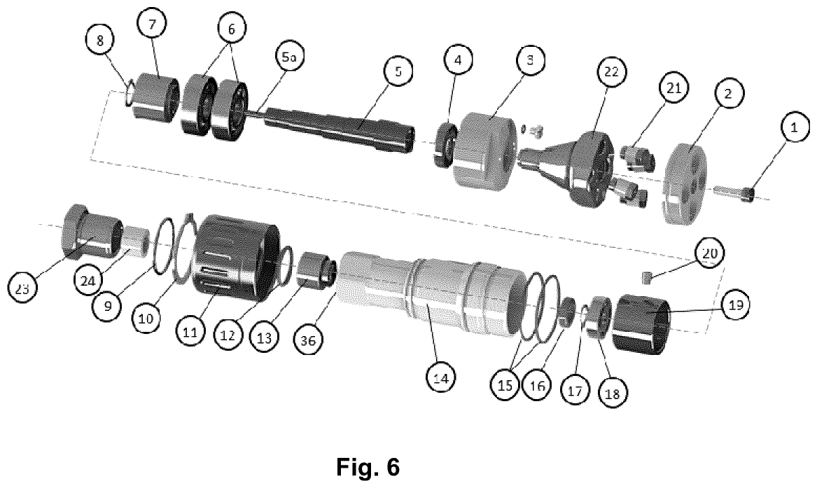

Furthermore, the nozzle holder 22 is configured to accommodate the fixing screw 1 and the nozzles 21 in cavities, for example, by means of threaded connections. In FIG. 6, four nozzles 21 are observed, but it is clear to a person skilled in the art that different quantities of nozzles can be used.

The front nut 3 is adapted to be connected to the body 14, for example via a threaded connection. An O-ring 15 assists in the sealing between the front nut 3 and the body 14. Furthermore, the retainer 4 allows the coupling between the front nut 3 and the mechanical shaft 5, preventing oil leakage.

The ball bearings 6, 18 are connected to the mechanical shaft 5, preferably upstream and downstream of the brakes 26, 27 in relation to the fluid flow direction. In this way, the bearings 6, 18 assist in the rotation of the rotating structure of the tool 25. By way of example, two bearings 6 can be arranged downstream of the brakes 26, 27 and one bearing 18 can be arranged upstream of the brakes 26, 27, taking the fluid flow direction as reference.

In one embodiment, the mechanical shaft 5 also connects to the retainer 16 and the elastic ring 17, arranged around the mechanical shaft 5. The retainer 16 and the elastic ring thus ensure coupling between said mechanical shaft 5 and the body 14.

The handle 11 is arranged to surround the body 14. In one embodiment, the rotation speed of the rotating structure of the tool 25 can be adjusted based on the movement of the handle 11, exclusively in the case of using a brake 26, in relation to the body 14. For example, a rotation of the handle 11 relative to the body 14, performed manually by the operator, can be configured to increase or decrease the rotation speed of the rotating structure.

Furthermore, the O-rings 9 and 15 arranged along the body 14 help seal between the handle 11 and the body 14.

It is worth noting that the elastic ring 10 is configured to be received in a recess in the body 14 and acts as a barrier to movement of the handle 11 beyond a pre-established limit.

The limiting screw 20, exclusively when using brake 26, can be removed to apply/replace oil in it. In particular, the operator can remove the elastic ring 10 and then the handle 11, leaving the body gap 14 exposed for removing the limiting screw 20 and subsequent application/replacement of oil in the magnetic brake 26.

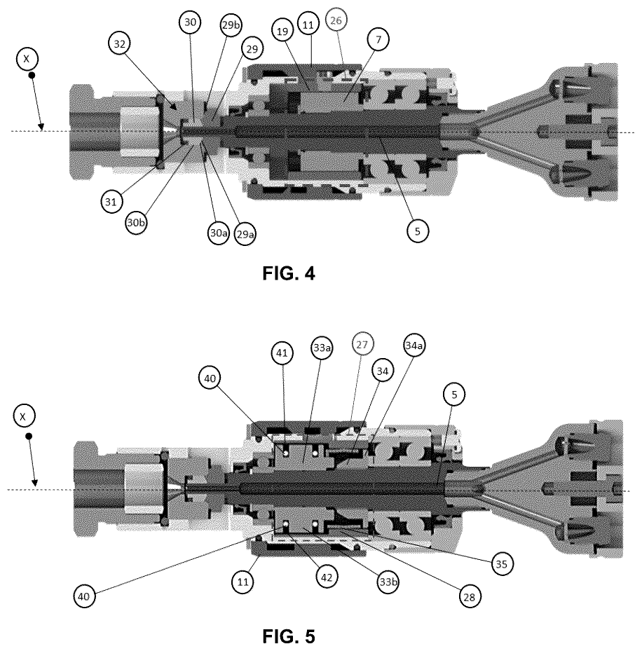

As seen in FIGS. 4 and 5, in an assembled configuration of tool 25, nozzles 21 and nozzle holder 22 fluidly connect to mechanical shaft 5, allowing pressurized fluid to exit.

Furthermore, the washer 24 has a cylindrical tubular shape and comprises an internal cavity also of cylindrical shape and internal thread, which connects to a high pressure tube and performs mechanical fixation between said tube, the adapter 23 and the cavity 36.

In general, components that are not directly part of the construction of the brakes 26, 27 can be used in any configuration of the tool 25, ensuring flexibility for the operator to determine the appropriate type of brake based on the requirements of each service.

The sealing cartridge 13 of the present invention has a simple configuration, with few components, which advantageously facilitates the maintenance of the tool 25 by the operator in the field.

Furthermore, the sealing cartridge 13 is adaptable to different types of brakes, and can be used to seal the hydroblasting tool 25 with a centrifugal brake 27 or magnetic brake 26, thus advantageously allowing greater flexibility to the operator when changing the brake of the tool 25.

Another advantage of the present invention is the versatile configuration of the hydroblasting tool 25, which allows different types of brakes to be used on the same set of parts, facilitating the use of the tool for the operator, who can perform brake changes. For example, the operator can switch between a centrifugal 27 or magnetic 26 brake whenever necessary.

Furthermore, another advantage of the invention is that the same sealing cartridge 13 can be used for both types of brakes, which is adaptable to different types of brakes.

Another advantage of the present invention is that the centrifugal brake 27 reduces the jamming effect during the operation of the tool 25 and also reduces the costs and complexity of its manufacturing process.

Although the description of particular embodiments above makes reference to certain embodiments, the present invention may present modifications in its form of implementation, so that the scope of protection of the invention is limited solely by the content of the attached claims, including possible equivalent variations.

1. A sealing cartridge (13) for a hydroblasting tool (25) comprising:
a sealing body (30) comprising a first through hole (37), a first sealing body surface (30a), and a second sealing body surface (30b);
a support (29) comprising a second through hole (38), a first support surface (29a), and a second support surface (29b); and
a guide (32) comprising a first guide surface (32a) delimiting an opening (39) and a second guide surface (32b) disposed around the opening (39);
wherein the first through hole (37), the second through hole (38), and the opening (39) are axially aligned and define a fluid passage;
the first support surface (29a) connects with the first sealing body surface (30a);
the second support surface (29b) connects with the second guide surface (32b); and
the first guide surface (32a) connects with the second sealing body surface (30b).

2. The sealing cartridge (13) of claim 1, wherein the support (29) is manufactured from a metallic material.

3. The sealing cartridge (13) of claim 1, wherein the hydroblasting tool (25) is a rotating nozzle.

4. The sealing cartridge (13) of claim 1, wherein the first surface of the sealing body (30a) has a frusto-conical shape and the first support surface (29a) has a shape corresponding to the frusto-conical shape of the first sealing body surface (30a).

5. The sealing cartridge (13) of claim 1, wherein at least one part of the opening (39) has a cylindrical shape and the second sealing body surface (30b) has a circular cross-section.

6. The sealing cartridge (13) of claim 1, wherein a joint (31) provides a seal between the first guide surface (32a) and the second sealing body surface (30b).

7. The sealing cartridge (13) of claim 6, wherein the second surface of the sealing body (30b) comprises a shoulder (30c), wherein the joint (31) is disposed on the shoulder (30c).

8. The sealing cartridge (13) of claim 6, wherein the joint (31) has a toroidal shape and the shoulder (30c) has a circular shape.

9. The sealing cartridge (13) of claim 6, wherein the sealing body (30), the support (29), the sealing guide (32), and the joint (31) are arranged coaxially with respect to a geometric axis (X).

10. The sealing cartridge (13) of claim 9, wherein the first and second support surfaces (29a, 29b) comprise circular shoulders arranged concentrically around the geometric axis (X).

11. The sealing cartridge (13) of claim 9, wherein the fluid passage is parallel to the geometric axis (X).

12. A hydroblasting tool (25) comprising:
a main structure comprising a geometric axis (X);
a rotating structure configured to rotate around the geometric axis (X); and
a sealing cartridge (13);
wherein the sealing cartridge (13) is configured to provide a seal between the rotating structure and the main structure;
the sealing cartridge (13) comprising:
a sealing body (30) comprising a first through hole (37), a first sealing body surface (30a) and a second sealing body surface (30b);
a support (29) comprising a second through hole (38), a first support surface (29a) and a second support surface (29b); and
a guide (32) comprising a first guide surface (32a) delimiting an opening (39), a second guide surface (32b) disposed around the opening (39) and a third through hole (47) in fluid communication with the opening (39);
wherein the opening (39), a pressurized fluid pocket (48) and a third through hole (47) are configured to be axially aligned and define a fluid passage;
the first support surface (29a) is configured to connect with the first sealing body surface (30a);
the second support surface (29b) is configured to connect with the second guide surface (32b); and
the first guide surface (32a) is configured to connect with the second sealing body surface (30b).

13. The hydroblasting tool (25) of claim 12, wherein the hydroblasting tool (25) is a rotating nozzle and the rotating structure comprises a brake for controlling the rotation speed.

14. The hydroblasting tool (25) of claim 13, wherein the brake is interchangeable and is selected from the group consisting of a magnetic brake (26) and a centrifugal brake (27).

15. The hydroblasting tool (25) of claim 12, wherein the main structure comprises a body (14) and the rotating structure comprises a mechanical axis (5), wherein the body (14) comprises a cavity (36) for receiving the mechanical shaft (5) and the sealing cartridge (13); wherein the fluid passage receives is one end of the mechanical shaft (5).

16. The hydroblasting tool (25) of claim 15 comprising an adapter (23) to fluidically connect a fluid source to the fluid passage; wherein the adapter (23) is received in the cavity (36) of the body (14) and an adapter joint (12) performs locking between the cartridge (13) and the cavity (36) of the body (14).

17. The hydroblasting tool (25) of claim 16, wherein at least a part of the opening (39) is fluidically connected to the adapter (23) and funnel towards the fluid passage.

18. The hydroblasting tool (25) of claim 13 comprising a magnetic brake (26) or a centrifugal brake (27) surrounding the mechanical axis (5) for controlling the rotation speed, wherein the magnetic brake (26) comprises a magnetic rotor (7) and a tubular electrical conductor (19) immersed in oil; the centrifugal brake (27) comprising a first weight element (33a), a second weight element (33b), a centrifugal shaft (34), and an elastic element (35).

19. A hydroblasting tool (25) comprising:
a main structure comprising a geometric axis (X); and
a rotating structure; the rotating structure being configured to rotate around the geometric axis (X);
wherein the rotating structure comprises a centrifugal brake (27) for controlling rotation speed, the centrifugal brake (27) comprising a first weight element (33a), a second weight element (33b), a centrifugal shaft (34), and an elastic element (35),
wherein the first weight element (33a) comprises a first gap (41) and the second weight element (33b) comprises a second gap (42);
wherein the first gap (41) connects with the second gap (42) and the weight elements (33a; 33b) are secured to each other by an elastic component (40) disposed along the first gap (41) and the second gap (42);
the weight elements (33a, 33b) surrounding at least a part of the centrifugal shaft (34); and
the elastic element (35) surrounds at least one end of the weight elements (33a, 33b) and at least one end of the centrifugal shaft (34a).

20. The hydroblasting tool (25) of claim 19, wherein the first weight element (33a) comprises a first cavity (43) and the centrifugal shaft (34) comprises a second cavity (44), wherein the first and second cavities (43, 44) receive ends (45, 46) of the elastic element (35).
